(19) United States
(12) Patent Application Publication
(10) Pub. No.: US 2010/0259826 A1
(43) Pub. Date: Oct. 14, 2010

(54) PLANAR PLASMONIC DEVICE FOR LIGHT REFLECTION, DIFFUSION AND GUIDING

(75) Inventors: Jin Ji, Boston, MA (US); Mark B. Spitzer, Sharon, MA (US); Lawrence A. Kaufman, Waltham, MA (US)

Correspondence Address: Milstein Zhang & Wu LLC, 49 Lexington Street, Suite 6, Newton, MA, 02465-1062, US

(73) Assignee: Lightwave Power, Inc., Cambridge, MA (US)

(21) Appl. No.: 12/758,373

(22) Filed: Apr. 12, 2010

Related U.S. Application Data
(60) Provisional application No. 61/168,292, filed on Apr. 10, 2009.
(60) Provisional application No. 61/177,449, filed on May 12, 2009.

(51) Int. Cl. G02B 5/02

(52) U.S. Cl. 359/599

(57) ABSTRACT

A planar plasmonic device includes a first material layer having a surface configured to receive at least one photon of incident light. A patterned plasmonic nanostructured layer is disposed adjacent and optically coupled to the first material layer. The patterned plasmonic nanostructured layer includes a selected one of: a) at least a portion of a surface of the patterned plasmonic nanostructured layer includes a textured surface, and b) at least one compound nanofeature including a first material disposed adjacent to a second material within the compound nanofeature.

### CROSS-REFERENCE TO RELATED APPLICATIONS

This application claims priority to and the benefit of co-pending U.S. provisional patent application Ser. No. 61/168,292, PLANAR PLASMONIC DEVICE FOR LIGHT REFLECTION, DIFFUSION AND GUIDING, filed Apr. 10, 2009, and co-pending U.S. provisional patent application Ser. No. 61/177,449, PATTERNED PLANAR DEVICES AS INTERMEDIATE LIGHT DISTRIBUTING AND GUIDING LAYERS IN SOLAR CELLS, filed May 12, 2009, which applications are incorporated herein by reference in their entirety.

### FIELD OF THE INVENTION

The invention relates to a planar plasmonic device in general and particularly to a planar plasmonic device employing a textured surface or a compound nanofeature.

### BACKGROUND OF THE INVENTION

The energy conversion efficiency and cost of a photovoltaic cell is directly related to the thickness of the absorbing layer. The importance of the thickness to conversion efficiency arises from the physics of the absorption process as described by Beer's Law. According to Beer's Law, the thicker the absorbing layer, the more light that is absorbed, and ultimately converted to electrical energy. Since absorption efficiency is also a function of wavelength, absorption over the entire solar spectrum should be considered when selecting and designing absorbers for solar cell applications.

In terms of economic efficiency, the cost of an absorbing layer is related to both the raw material cost and the manufacturing cost. While absorption efficiency increases with thickness, the cost of solar cell production increases with increased thickness. Further complicating the trade-offs between energy conversion efficiency and cost efficiency, many absorbers are made from scarce material resources, such as cadmium telluride. Therefore a reduction of material thickness can make possible an increase in total solar cell production numbers for the scarce resources.

Turning now to another engineering trade-off, in a typical crystalline silicon solar cell, recombination losses can be reduced by making the cell thin, leading to higher operating voltage. However, a thinner cell, having a thinner absorber, absorbs less light. With less light absorption, the photo-generated current is reduced, especially for long wavelength photons that are weakly absorbed and which would otherwise need a substantial amount of silicon for more efficient light absorption. In prior art structures, photons in a range of 400 nm to 500 nm may require a few micro-meters of Si for absorption of 99% of the energy, and infrared photons may require several hundred micro-meters to reach 99% absorption. Also, photons that are absorbed deep in the semiconductor must diffuse to the p-n junction to be collected, which increases the chance of recombination, leading to a lower light energy to electrical energy conversion efficiency.

What is needed, therefore, is a relatively thin solar cell structure that has a relatively low rate of recombination while more efficiently absorbing photons.

### SUMMARY OF THE INVENTION

In one aspect, a planar plasmonic device includes a first material layer having a surface configured to receive at least one photon of incident light. A patterned plasmonic nanostructured layer is disposed adjacent and optically coupled to the first material layer. The patterned plasmonic nanostructured layer includes a selected one of: a) at least a portion of a surface of the patterned plasmonic nanostructured layer includes a textured surface, and b) at least one compound nanofeature including a first material disposed adjacent to a second material within the compound nanofeature.

In one embodiment, the first material layer includes a silicon wafer.

In another embodiment, the planar plasmonic device includes an amorphous silicon layer with a superstrate structure.

In yet another embodiment, the patterned plasmonic nanostructured layer includes a plurality of nanofeatures having a shape selected from the group of shapes consisting of round, triangular, elliptical, cylindrical, square, rectangular, regular polygon, and irregular polygon.

In yet another embodiment, the patterned plasmonic nanostructured layer includes a plurality of nanofeatures having a selected one of physical feature of depression and physical feature of protrusion.

In yet another embodiment, the patterned plasmonic nanostructured layer includes a plurality of nanofeatures including patches of a metal.

In yet another embodiment, the patterned plasmonic nanostructured layer includes a patterned metal film.

In yet another embodiment, the patterned metal film includes a textured surface.

In yet another embodiment, the patterned metal film is disposed adjacent to a textured surface, the textured surface is provided on a selected one of a surface of the first material and a surface of the second material.

In yet another embodiment, the metal film includes a metal selected from the group consisting of silver, gold, copper, aluminum, nickel, titanium, chromium, silver alloy, gold alloy, copper alloy, aluminum alloy, nickel alloy, titanium alloy, chromium alloy, and a combination thereof.

In yet another embodiment, the first material and the second material of the at least one compound nanofeature are a first metal and a second metal, respectively.

In yet another embodiment, the patterned plasmonic nanostructured layer includes a plurality of nanofeatures formed on a surface of the first material layer and at least some of the plurality of nanofeatures are coated with a material that supports plasmon waves.

In yet another embodiment, the material that supports plasmon waves includes a metal selected from the group consisting of silver, gold, copper, aluminum, nickel, titanium, chromium, silver alloy, gold alloy, copper alloy, aluminum alloy, nickel alloy, titanium alloy, chromium alloy, and a combination thereof.

In yet another embodiment, the material that supports plasmon waves includes a transparent conductive oxide material.

In yet another embodiment, the transparent conductive oxide material is an oxide selected from the group consisting of indium-tin-oxide (ITO) and zinc oxide (ZnO).

In yet another embodiment, the planar plasmonic device further includes at least one solar cell layer electrically coupled within an integrated solar cell having an integrated solar cell positive terminal and an integrated solar cell negative terminal.

In yet another embodiment, the planar plasmonic device further includes a mirror.

In yet another embodiment, the planar plasmonic device further includes at least one wavelength conversion layer.

In yet another embodiment, the planar plasmonic device is configured as a selected one of a front layer of an integrated solar cell and a rear layer of the integrated solar cell.

In yet another embodiment, the planar plasmonic device includes a quarter-wave coating anti-reflective material.

The foregoing and other objects, aspects, features, and advantages of the invention will become more apparent from the following description and from the claims.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

FIG. 1 shows a cross sectional diagram of a prior art patterned semiconductor optical device.

FIG. 2 shows a cross section diagram of a planar plasmonic optical device.

FIG. 3 shows a plan view of the nanofeatures of the planar plasmonic device of FIG. 2.

FIG. 4A shows an illustration of one exemplary embodiment of a planar plasmonic device having a Lambertian surface.

FIG. 4B shows a cross section diagram of a planar plasmonic device having a patterned metal film with a textured surface.

FIG. 4C shows a cross section diagram of a self supporting planar plasmonic device.

FIG. 4D shows a cross section diagram of another self supporting planar plasmonic device illuminated on the opposite side as the device of FIG. 4C.

FIG. 5 shows one exemplary integrated solar cell having a planar plasmonic device as a back reflector.

FIG. 6A shows one exemplary integrated solar cell having a planar plasmonic device as a front reflector.

FIG. 6B shows one exemplary integrated solar cell having a first planar plasmonic device as a back reflector and a second planar plasmonic device as a front reflector.

FIG. 7 shows an exemplary cross-section diagram integrated solar cell having a planar plasmonic device with compound nanofeatures.

FIG. 8 shows a cross-section drawing of an integrated solar cell having a planar plasmonic device layer that replaces an anti-reflection coating.

FIG. 9 shows a cross-section diagram of an integrated solar cell a planar plasmonic device layer and a wavelength conversion layer.

### DETAILED DESCRIPTION

### Definitions

Integrated solar cell: We refer herein to a complete solar cell assembly of layers as an “integrated solar cell”. The term integrated solar cell, includes integrated structures made using both conventional semiconductor manufacturing methods, e.g. photolithography and vapor deposition, as well as layers manufactured in part or entirely by more recent fabrication methods, such as for example, nanofabrication methods.

Solar cell layer: The absorber of an integrated solar cell is referred to interchangeably herein as a “solar cell layer”. It is understood that one or more solar cell layers are electrically coupled within an integrated solar cell to provide an integrated solar cell electrical output voltage across an integrated solar cell positive terminal and an integrated solar cell negative terminal. In some embodiments a metal film present for optical reasons can also, but not necessarily, provide as an electrical connection to a solar cell layer.

Modification of light: Modification of light as used herein includes a change in direction of propagation and/or a change in wavelength of the light.

As described hereinabove, in prior art solar cell structures, there is a trade-off between the thickness of solar cell layers, particularly the thickness of the absorbing layer, the corresponding cost and availability of materials and conversion efficiency of light energy to electrical energy. The optical solution described hereinbelow which allows for less thick structures, while maintaining relatively high conversion efficiency is a new approach to light collection. The new approach, a planar plasmonic device, can be applied in light-collecting optics for solar cells. Our planar plasmonic device technology provides a new way to concentrate light and thereby increase efficiency, reduce material consumption, and lower the cost of solar cells. It is believed that planar plasmonic devices can be described at least part by light trapping. Light trapping is described in more detail hereinbelow in the section entitled, light trapping and theoretical background.

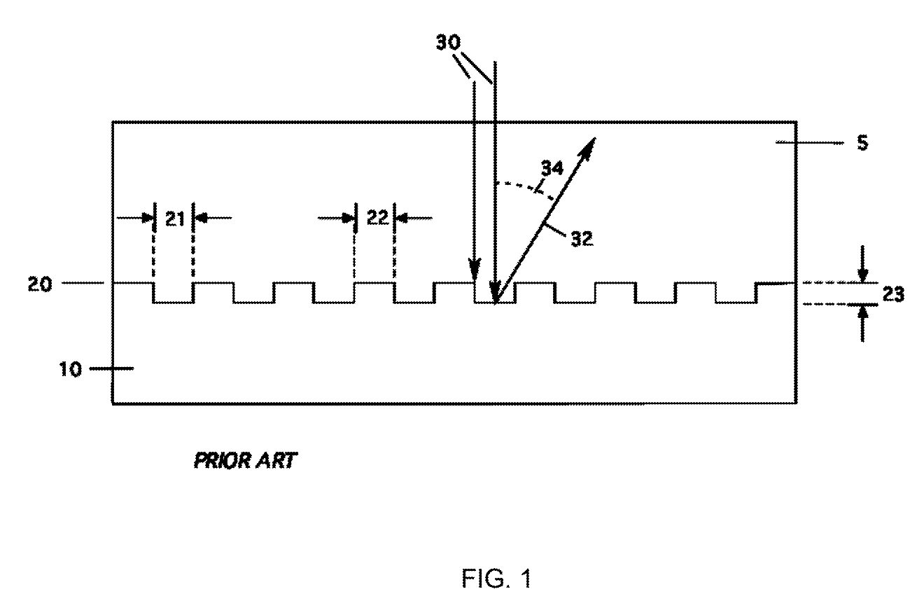

We begin by describing a semiconductor optical device of the prior art. FIG. 1 shows a cross sectional diagram of a prior art patterned semiconductor optical device. The device of FIG. 1 controls light by use of a diffraction grating at the back of a solar cell layer. An absorbing semiconductor 5 is patterned at the interface 20 between the absorbing semiconductor 5 and a material 10. Material 10 has a periodic pattern characterized by features having a depth 23, a width 21 and spacing 22. The periodicity of the grating is the sum of the dimensions width 21 and spacing 22. Incident photons represented by light rays 30 having a wavelength λ are reflected from the interface of absorber 5 and material 10 and undergo interference to produce photons represented by light ray 32 which are diffracted into an angle 34. Angle 34 is dependent on λ. The reflected photons represented by light ray 32 may be trapped if angle 34 is greater than the critical angle for total internal reflection (TIR). The critical angle for TIR depends on the index of refraction of material 5 and the surrounding media.

### Planar Plasmonic Device

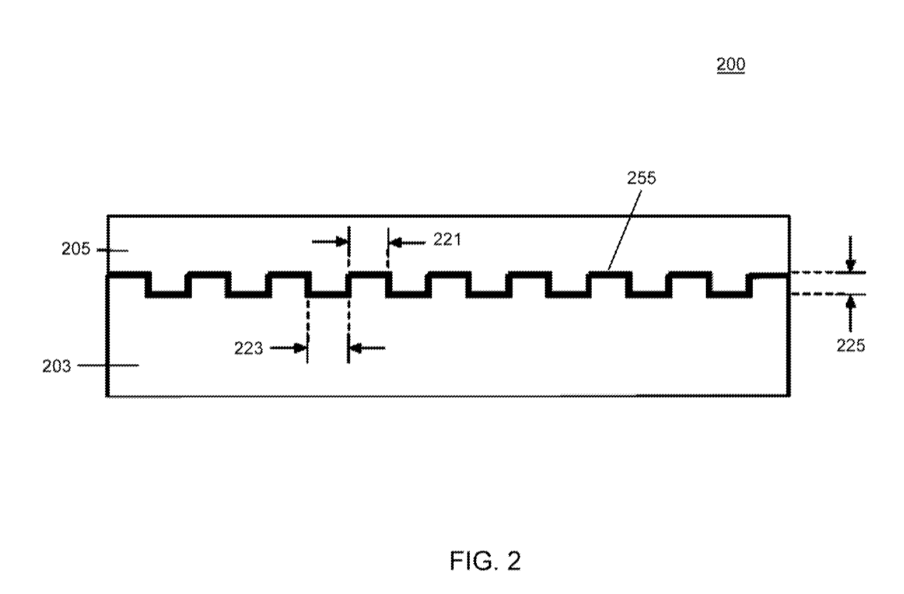

The prior art device of FIG. 1 can be improved by making use of plasmonic waves or surface plasmonic polaritons (SPP) to modify the wavelength dependence of the scattering angles and thereby attain an improvement in light trapping by TIR. FIG. 2 shows a cross section diagram of a planar plasmonic device 200 useful for light reflection, diffusion and guiding. Planar plasmonic device 200 has a metal film 255 at an interface between a material 203 and an absorbing material 205. The metallic film supports SPP modes that affect the propagation of light scattered at the interface. A thin film of plasmonic nanostructures (e.g. thin film 255, FIG. 2) can be made on any material that supports plasmon waves.

Alternatively, plasmonic nanostructures can be fabricated by patterning nanostructures in any suitable substrate including silicon and polymer substrates, and then coating the structures conformally with a material that can support plasmon waves. Materials that support plasmonic waves include electrically conductive materials made from gold, silver, chromium, titanium, copper, and aluminum or any suitable combination thereof. An electrically conductive material can also be made from a transparent conductive oxide. Examples of such materials are indium-tin-oxide (ITO) or zinc oxide (ZnO).

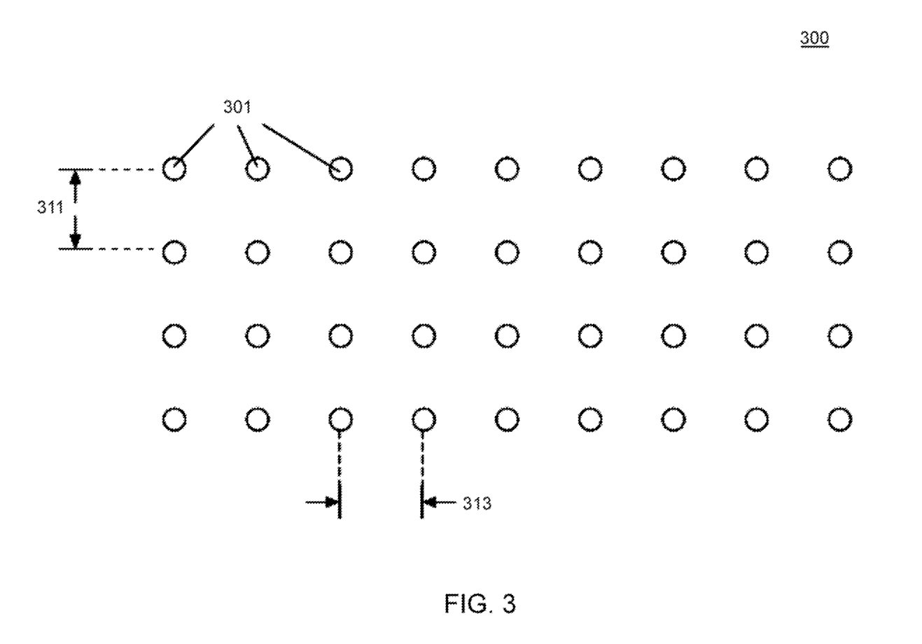

FIG. 3 shows a plan view of the nanofeatures of the planar plasmonic device of FIG. 2. Features 301 can be disposed in a regular array, such as an array having an inter-feature distance 311 along a first axis and an inter-feature distance 313 along a second axis not parallel to the first axis. Such nanofeatures can also be disposed in an irregular or random pattern. The inter-feature distance 311 and inter-feature distance 313 can, for example, be on the order of the wavelength of light in the solar spectrum.

The nanofeatures of any of the embodiments of planar plasmonic devices described herein can be round, triangular, elliptical, cylindrical, square, rectangular, and/or of a regular or irregular polygon or any other suitable shape. While the nanofeatures are shown in FIG. 2 as depressions of depth 225, such nanofeatures can also be viewed as protrusions having a height 225. Such features can also be present as apertures through the film 255. Such features can also be present as patches, such as for example, isolated patches or islands of metal.

The physical nanofeatures can also include any suitable combination of two or more types of protrusions, depressions, apertures, or voids. For example, a pattern can be formed from a shape having an aperture surrounded by one or more protrusions. Or, a pattern can be formed from a shape having a void surrounded by a plurality of depressions. The thickness of the metallic film 255 is typically in a range of about 50 to 500 nm. The pattern of such a plasmonic layer can have a variety of pattern distributions as described herein. As described hereinabove, a metallic film 255 and/or nanofeatures on or in a thin film can be made from metals such as gold, silver, chromium, titanium, copper, and aluminum or any suitable combination thereof. An electrically conductive material can also be made from a transparent conductive oxide. Examples of such materials are indium-tin-oxide (ITO) or zinc oxide (ZnO).

Diffraction and/or plasmonic resonant structures as described hereinabove can be added on the top and/or bottom surfaces of a planar device layer to influence the propagation direction of the reflected and transmitted electromagnetic waves, such as light waves. Depending on a solar cell design, the propagation angle of the light entering various solar cell layers can have an optimum range related to the maximum optical absorption path in a solar cell layer. Diffraction-grating based surface plasmon resonance has been utilized in medical and biological research where metallic gratings are used to generate resonance between surface plasmons to diffract light at various angles. Plasmonic half-shell nanocups have also been demonstrated to receive selected electromagnetic waves and direct their propagation. These principles can be used in the design of light directing features on a plasmonic layer to guide the propagation direction of the reflected and transmitted light. In this way, by placing diffraction or plasmonic resonant structures on any of the planar devices described herein, we can further control the direction, and therefore the angle of light propagation within various solar cell layers to obtain a more optimal absorption of light. Alternatively, or additionally, one or more surfaces can be textured to provide Lambertian scattering.

### Planar Plasmonic Device Having a Lambertian Surface

Optical devices such as those described hereinabove can be further improved by the addition of a Lambertian surface. A Lambertian surface is a surface that scatters light uniformly so that the apparent brightness of the surface to an observer is substantially the same regardless of the observer's angle of view. Lambertian surfaces have been utilized in many fields including solar cells to generate scattered light within the solar cell. Lambertian surfaces can be made, for example, by surface texturing. Depending on the surface texture process, in addition to Lambertian scattering, surface texturing can also provide scattering in preferred directions.

After the filing of our provisional applications whose priority is claimed, A. J. M. van Erven, et. al., “Periodic Texturing of Thin Film Silicon Solar Cell Superstrates”, 24th European Photovoltaic Solar Energy Conference, 21-25 Sep. 2009, Hamburg, Germany, described a combination of random texture and periodic structure for use in a solar cell that might improve the short circuit current of the solar cell through a combination of light diffraction and scattering effect.

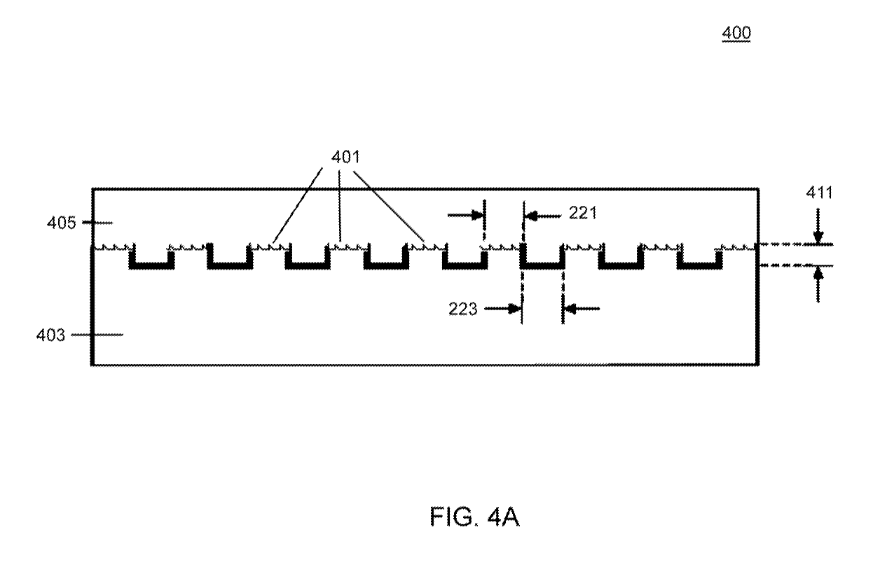

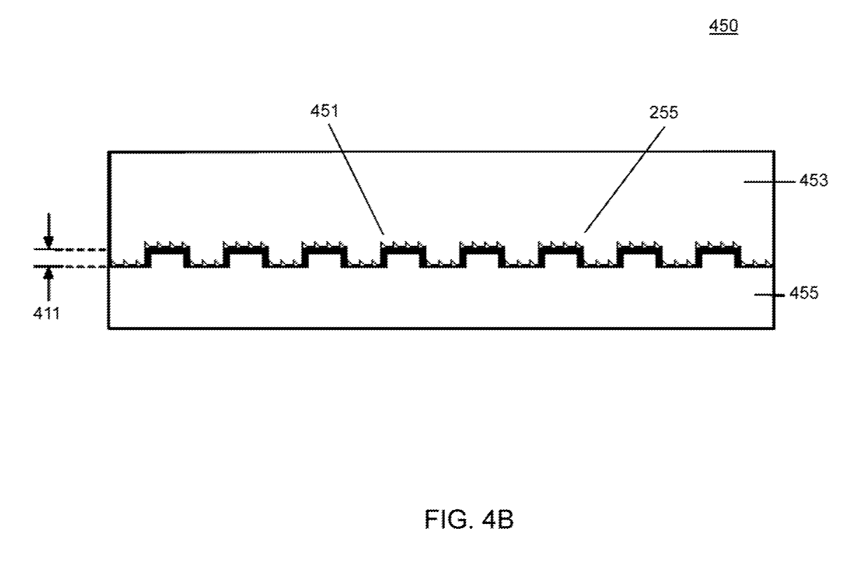

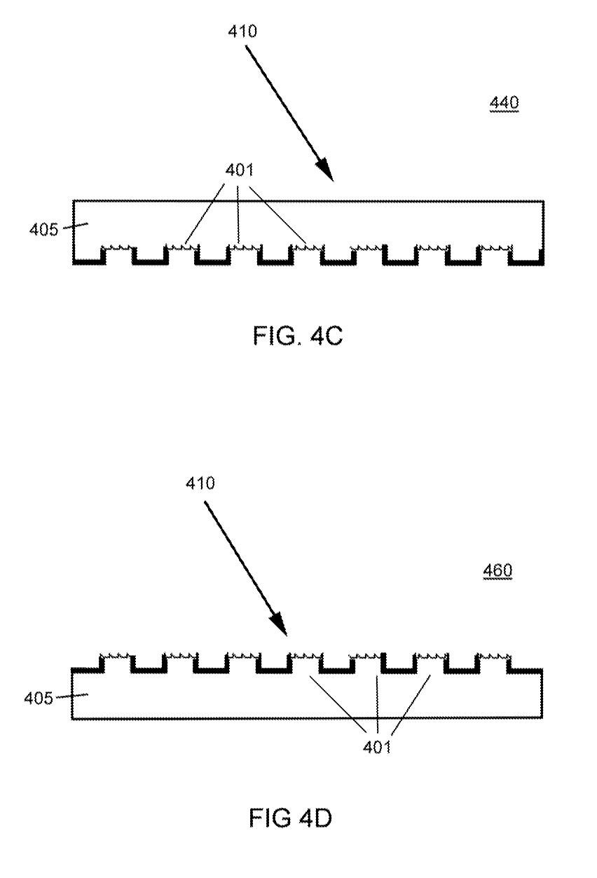

FIG. 4A shows an illustration of one exemplary embodiment of a planar plasmonic device 400 having a Lambertian surface. A surface of metal film 255 of the planar plasmonic device has been modified in a controlled manner to have a random or controlled texture 401. In some embodiments of the device of FIG. 4A, texture 401 can be formed in material 405, before the formation of layer 403. The structure of FIG. 4A is a plasmonic-textured device that takes advantage of both plasmonic and textured effects.

In prior art solar cell manufacture rough surfaces are avoided. Where a rough surface inadvertently results from one or more manufacturing steps, some sort of mechanical or chemical polishing step follows. However, according to the invention, a texture layer can be intentionally created, for example, by use of a sub micron lithography technique, or a more conventional roughening such as by plasma etching, by chemical methods, including chemical etching, vapor deposition that results in a rough surface, or other known roughening techniques. Such textures can have roughness features on the order of wavelengths of solar radiation. For example, it is believed that roughness features in a range of 10 nm to 500 nm can be used to make effective textured surface.

FIG. 4B shows another exemplary embodiment of a planar plasmonic devices having a Lambertian surface. In the embodiment of FIG. 4B, one of the surfaces of the patterned metal film 255 is textured. Such texturing can be accomplished by any suitable etching technique, including those described herein, or by coating a surface of patterned metal film 255 with a material that provides a textured surface.

In other embodiments of planar plasmonic devices, as shown by the cross-section diagram of FIG. 4C, a relatively thick first material 405 layer can be used to provide a self-supporting planar plasmonic device 440 structure illuminated by a light ray 410 that does not need a second material or substrate. Such embodiments can be made with a conventional several hundred micron thick silicon wafer (whether single crystal or polycrystalline) or by using a superstrate technology such as, for example, amorphous silicon deposited on glass. Such planar plasmonic devices combine the benefits of plasmons, diffraction and diffuse scattering. FIG. 4D shows a cross section diagram of another self supporting planar plasmonic device 460 illuminated by a light ray 410 on the opposite side as the device of FIG. 4C.

These “hybrid” planar plasmonic devices having both plasmonic interactions and conventional optical reflection, refraction, and/or scattering by textured surfaces, can be the most effective in reflecting or guiding the wavelength range of interest in a preferred angle for TIR.

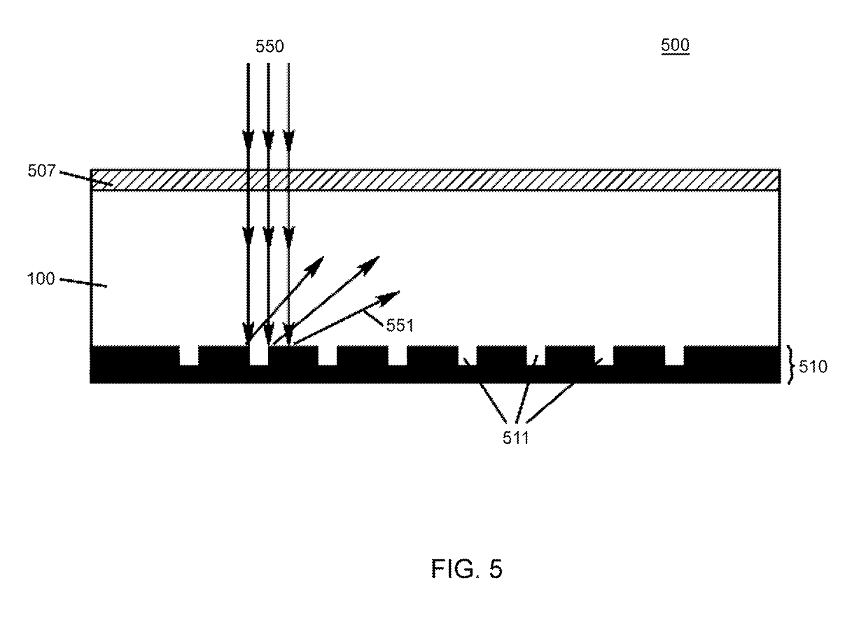

A planar plasmonic device can be incorporated into an integrated solar cell as a back-reflector and/or a front reflector to enhance light trapping in the solar cell layer. FIG. 5, for example, shows one exemplary integrated solar cell having a planar plasmonic device 510 as a back reflector. Integrated solar cell 500 includes solar cell layer 100, a conventional quarter wave anti-reflection coating 507 and a planar plasmonic device 510. Planar plasmonic device 510 includes a nanoarray of nanofeatures 511 at a second “back” surface of integrated solar cell 500.

Continuing with the embodiment of FIG. 5, in operation, light waves (photons of light) represented by light rays 550 incident on a first (“front”) surface of quarter wave anti-reflection coating 507 propagate to the planar plasmonic device 510 where the plurality nanofeatures 511 act to modify the light waves represented by light rays 550 so that after incidence on the planar plasmonic device 510, modified light waves, represented by light rays 551, propagate within the solar cell layer 100 towards a surface of quarter wave anti-reflection coating 507. The modification of the light waves, represented by light rays 551, is caused by a combination of surface plasmon effects, diffraction and reflection from the back nanoarray. Such modifications can include changes in direction as well as changes in wavelength.

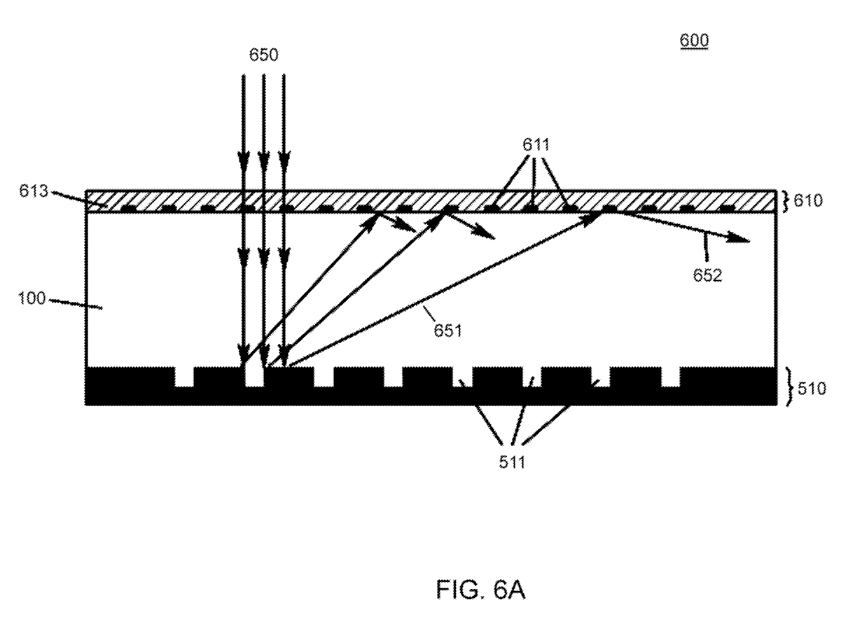

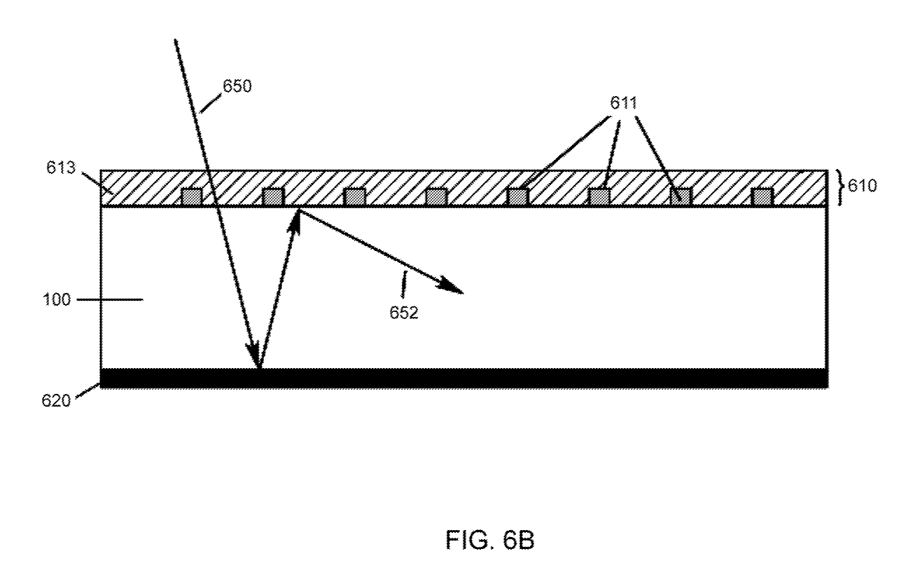

In addition to a planar plasmonic device on the “back” surface of an integrated solar cell, a planar plasmonic device can also be placed on the “front” surface. The addition of a planar plasmonic device on the front surface of an integrated solar cell can help to trap light propagating within the integrated solar cell. FIG. 6A shows an embodiment of one exemplary integrated solar cell having a planar plasmonic device on both the front and back of an integrated solar cell 600. The “back side” planar plasmonic device 510 can be substantially the same as planar plasmonic device 510 of FIG. 5. The “front” side planar plasmonic device 610 can include a plurality of nanofeatures 611 disposed within a quarter-wave coating 613. Light waves represented by light rays 650 are incident on the front of integrated solar cell 600. Light waves modified by planar plasmonic device 510 and represented by light rays 651 are again redirected through plasmonic interactions by planar plasmonic device 610 into modified light waves (e.g. modified with a new direction of propagation) represented by light rays 652. In this way the light wave can be more efficiently trapped in the solar cell layer 100.

FIG. 6B shows an embodiment of an integrated solar cell 650 having a “front” side planar plasmonic device 610, such as the planar plasmonic device 610 of FIG. 6A. In the embodiment of FIG. 6B, instead of the “back” side planar plasmonic device 510, there is a conventional mirrored layer 620.

### Planar Plasmonic Device Having Nanofeatures Having Two Types of Metals

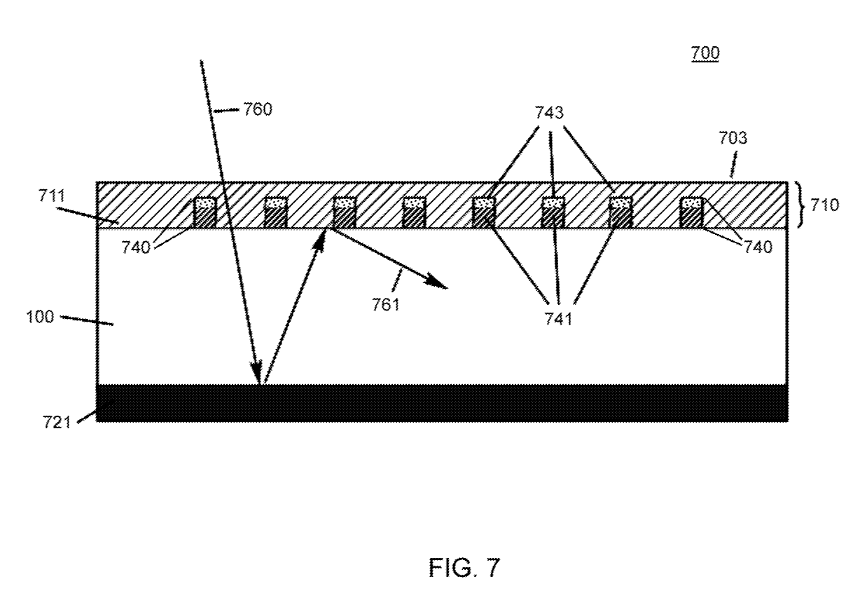

In another embodiment, it is believed that a planar plasmonic device having a nanoarray of compound nanofeatures having two different materials (e.g. two different types of metals or metal alloys) can advantageously change the plasmonic fields and improve the modification of light (e.g. direction or wavelength). A plurality of the compound nanofeatures has two or more different types of metals, such as in two or more distinct layers (as opposed to an alloy of two or more metals, although each type of distinct material can be made of a metal or metal alloy). As shown in the exemplary cross-section diagram integrated solar cell 700 of FIG. 7, a planar plasmonic device 710 made according to this aspect of the invention can also be used with a convention back surface reflector 721. A solar cell layer 100 is disposed adjacent to a reflector 721 at the back of integrated solar cell 700. Planar plasmonic device 710 includes a nanoarray of nanofeatures 740. A plurality of the nanofeatures 740 includes distinct sections of a first metal 741 and second metal 743. The nanoarray of nanofeatures 740 can be made using any of the materials and manufacturing techniques described herein. The difference of planar plasmonic device 710 over the previously described planar plasmonic devices is the compound nature of a plurality of the nanofeatures 740. The nanofeatures 740 can include the two types of materials in any suitable ratio by mass. For example, a nanofeature 740 can be made from equal masses or volumes of two types of materials, or there could be a relatively thick section of one type of material coated by a relatively thin surface coat of a second type of material.

In operation, photons, represented by light ray 760, pass through a first (“front”) surface 703 of the integrated solar cell 700 and propagate to the back side where some of the photons are reflected. Upon reaching planar plasmonic device 710 having a plurality of nanofeatures 740, the reflected ray is modified by the nanofeatures (e.g. modified in wavelength and/or direction) and continues to propagate within the cell as represented by light ray 761. In this way the light rays can be trapped within solar cell layer 100 of integrated solar cell 700.

### Improved Planar Plasmonic Device

As described hereinabove, a planar plasmonic device can be improved by the addition of a Lambertian surface. Also, as described hereinabove, a planar plasmonic device can be improved by use of a nanoarray of compound nanofeatures having two different materials (e.g. two different types of metals or metal alloys) that can advantageously change the plasmonic fields and improve the modification of light (e.g. direction or wavelength). Also, an improved a planar plasmonic device can include both a Lambertian surface and a nanoarray of compound nanofeatures having two different materials.

### Nanoarray in Place of an Anti-Reflection Coating

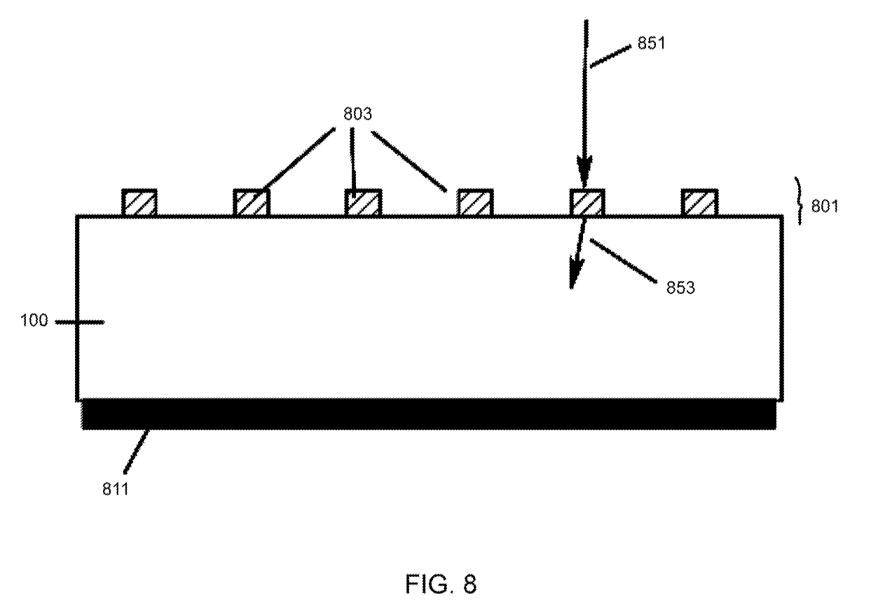

A nanoarray layer (such as for example, a planar plasmonic device layer) can also be used to replace an anti-reflection coating typically used on the “front” side of an integrated solar cell. FIG. 8 shows a cross-section drawing of an integrated solar cell 800 having a nanoarray 801 including nanofeatures 803. Nanoarray 801 is disposed on a first surface of a solar cell layer 100 at the “front” of integrated solar cell 800. In the exemplary embodiment of FIG. 8, there is also a back reflector or mirror layer, shown in FIG. 8 as surface reflector 811, disposed adjacent to the second surface of solar cell layer 100 at the back side of integrated solar cell 800.

In operation, the plurality of nanofeatures 803 on the front of integrated solar cell 800 absorb incoming photons of light represented by light ray 851 and re-emit photons of light represented by light ray 853. In addition to the anti-reflection, the nanoarray can also re-emit light 853 in a scattered direction. With a second (“back”) surface reflector 811, as shown in FIG. 8, some wavelengths of light can be substantially trapped within the absorber layer 100.

### Additional Wavelength Conversion Layers

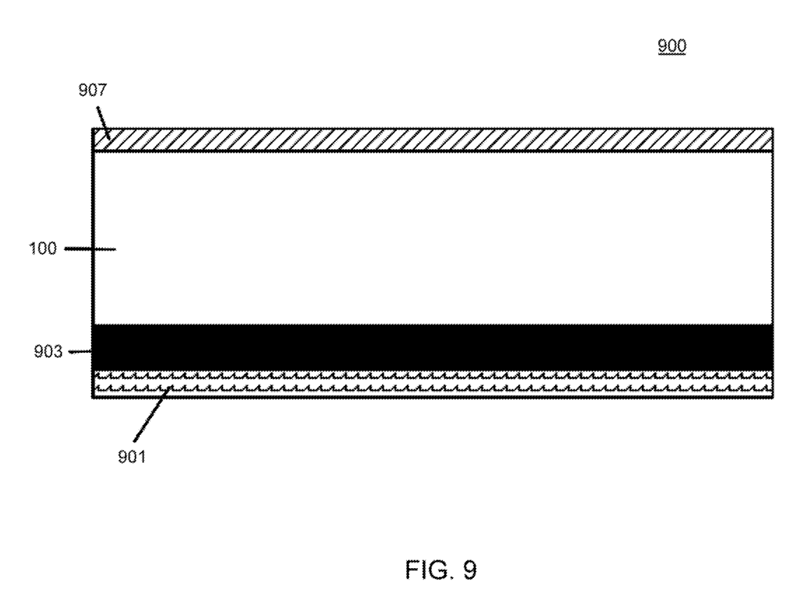

Embodiments of integrated solar cells including up and down conversion materials are also contemplated. For example, FIG. 9 shows a cross-section diagram of an integrated solar cell 900 that includes a nanoarray 901 (such as for example, a planar plasmonic device layer having a textured layer). Layer 903, a wavelength up-converting layer, is shown disposed between nanoarray 901 and a solar cell layer 100. A wavelength down-converting layer 907 can also be placed at the “front” of integrated solar cell 900. Suitable wavelength conversion layers have been described by the Lightwave Power Corporation, for example, in co-pending PCT Application No. PCT/US09/36815, entitled INTEGRATED SOLAR CELL WITH WAVELENGTH CONVERSION LAYERS AND LIGHT GUIDING AND CONCENTRATING LAYERS, filed Mar. 11, 2009, techniques of wavelength conversion layers in solar cells where the wavelength of an incident light can be converted to wavelengths more suitable for efficient absorption by particular photovoltaic (PV) layers of an integrated solar cell structure. The PCT/US09/36815 application is hereby incorporated herein by reference in its entirety for all purposes. Any of the integrated solar cell embodiments described herein, including integrated solar cells having nanoarrays (e.g. planar plasmonic devices) on the front, back, or both the front and the back of an integrated solar cell, can include one or more additional up or down converting layers, such as those described in the PCT/US09/36815 application.

### Multiple Layers

It is understood that there can be integrated solar cells having a plurality of planar plasmonic device layers. Such layers can, for example, cause modifications of selected wavelength ranges of light. It is also understood that a plurality of planar plasmonic device layers can be used in conjunction with a plurality of solar cell layers (“absorbers”), such as for example, where each of the plurality of solar cell layers are more efficient energy converters over different wavelength ranges. It is also understood that a plurality of planar plasmonic device layers can be used in conjunction with a plurality of wavelength conversion layers.

### Exemplary Methods and Materials of Manufacture

Dennis Slafer of the MicroContinuum Corporation of Cambridge, Mass., has described several manufacturing techniques and methods that are believed to be suitable for the manufacture of planar plasmonic devices and device layers as described herein. For example, U.S. patent application Ser. No. 12/358,964, ROLL-TO-ROLL PATTERNING OF TRANSPARENT AND METALLIC LAYERS, filed Jan. 23, 2009, published as US 2009/0136657 A1 describes and teaches one exemplary manufacturing process to create metallic films having a plurality of nanofeatures suitable for use in surface plasmon wavelength converter devices as described herein. Also, U.S. patent application Ser. No. 12/270,650, METHODS AND SYSTEMS FOR FORMING FLEXIBLE MULTILAYER STRUCTURES, filed Nov. 13, 2008, published May 28, 2009 as US 2009-0136657 A1, U.S. patent application Ser. No. 11/814,175, REPLICATION TOOLS AND RELATED FABRICATION METHOD AND APPARATUS, filed Aug. 4, 2008, published Dec. 18, 2008 as US 2008-0311235 A1, U.S. patent application Ser. No. 12/359,559, VACUUM COATING TECHNIQUES, filed Jan. 26, 2009, published Aug. 6, 2009 as US 2009-0194505 A1, and PCT Application No. PCT/US2006/023804, SYSTEMS AND METHODS FOR ROLL-TO-ROLL PATTERNING, filed Jun. 20, 2006, published Jan. 4, 2007 as WO 2007/001977, describe and teach related manufacturing methods which are also believed to be useful for manufacturing planar plasmonic devices and device layers and integrated solar cells having planar plasmonic devices as described herein. Each of the above identified United States and PCT applications is hereby incorporated herein by reference in its entirety for all purposes.

Laser interferometry is another manufacturing process that is believed to be suitable for the manufacture of planar plasmonic devices and other device layers as described herein. For example, in U.S. Pat. No. 7,304,775, Actively stabilized, single input beam, interference lithography system and method, D. Hobbs and J. Cowan described an interference lithography system that is capable of exposing high resolution patterns in photosensitive media and employing yield increasing active stabilization techniques. U.S. Pat. No. 7,304,775 is hereby incorporated herein by reference in its entirety for all purposes.

In one exemplary process, a substrate is coated with photoresist, and exposed to a laser source at defined regions that represent a complementary pattern of the desired nanopattern. Then the photoresist material is developed and the complementary nanopattern is formed in the photoresist material. This complementary nanopattern is then used as a template for the next stage in the process, which consists of deposition of the nanopatterned material (gold, silver, etc.) through a number of deposition techniques such as electron-beam evaporation and sputtering deposition. The remaining photoresist is then lifted off by chemical reagents, leaving behind the desired planar plasmonic device or device layer.

Turning now to materials useful for the manufacture of planar plasmonic devices and device layers, planar plasmonic devices and device layers can be made of any suitable conductor, such as for example, silver, gold, copper, aluminum, nickel, titanium, chromium, silver alloy, gold alloy, copper alloy, aluminum alloy, nickel alloy, titanium alloy, chromium alloy, or any combination thereof. Apertures (e.g., voids, holes, or nanofeatures) and/or media (e.g., dielectric media) can be present as a dielectric material, such as for example, a gas, air or silicon dioxide or a transparent conducting oxide such as tin oxide, zinc oxide, or indium tin oxide, or a semiconducting material such as silicon in any suitable form, such as for example, amorphous, crystalline, microcrystalline, nanocrystalline, or polycrystalline silicon. Copper indium gallium selenide (CIGS), and cadmium telluride (CdTe) are believed to be other suitable semiconducting materials. The apertures and/or media can be of different materials.

Other embodiments of planar plasmonic devices and device layers (not shown in the drawings) can include combinations of any of the above structures. Where nanofeatures of planar plasmonic devices and device layers include apertures, suitable apertures can take any form, including but not limited to, round or elliptical holes, slits, polygons, or irregular shapes. Resonant features can be of any suitable shape or morphology such as, but not limited to, ridges, bumps, depressions, and can be formed in any pattern including rings or gratings surrounding the aperture. The plurality of apertures as described in various embodiments can be periodic, non-periodic, or any combination thereof.

The shape and pattern of these intermediate light guiding nanostructures, whether they are apertures or nanoparticles, may vary and may comprise regular or irregular polygons, circles, ellipses or other geometric pattern. The thickness of the planar device 119 has a dimension that may vary from a dimension comparable to a skin depth of a photon of solar light or to several hundreds of nanometers. The pattern of the nanostructured planar device can include a plurality of shapes such as, rods, rectangles, triangles, linear ridges, circular ridges, spiral ridges, and stars. Each one of the shapes can also have a physical dimension of about a wavelength of light, such as in a wavelength range of the terrestrial solar spectrum (300 nm to 2000 nm).

Nanoarrays as described herein can include a regular array of nanoparticles or nano-apertures in a periodic pattern. Alternatively, there can be a random or non-periodic pattern of nanostructures. Nanoarrays can also include an array of nano-apertures, or alternatively a pattern of indentations that do not extend all the way through a thin film. A nanoarray can also include nanofeatures as an array of voids between two surfaces. Such physical features can also include any combination of two or more types of protrusions, depressions, apertures, or voids. For example, a pattern can be formed from a shape having an aperture surrounded by one or more protrusions. Or, a pattern can be formed from a shape having a void surrounded by a plurality of depressions.

In the below text, unless otherwise stated, all intermediate light guiding planar devices include the concept of a plain intermediate light guiding device or a nanopatterned-Lambertian device.

### Light Trapping and Theoretical Background

Embodiments of the invention include a patterned metallic planar layer to guide the direction of light of selected wavelengths so as to trap the photons within an absorbing layer adjacent to this planar metallic device, or to control the reflectance or other optical properties of a layer. By trap, we mean that a device or device layer causes light, once transmitted to an absorbing layer, to remain in the absorbing semiconductor or light guide until it is fully absorbed. By use of light trapping, the absorber can be made thinner, thus reducing cost. When light is trapped in a thin layer of an absorber, and made to propagate at a high angle compared to the surface normal vector, the thickness of the absorber becomes much less important to the conversion efficiency, and in some cases can improve the efficiency.

Thin films that can control the propagation direction of light of certain wavelengths are desirable in the solar industry since they can be applied to redirect and trap light that otherwise would escape the solar cell before absorption. The concept of light trapping has been known in the prior art for at least 30 years. One prior art approach is to use a randomly textured back reflector or random scattering by a front layer. Both approaches scatter light approximately uniformly into a plurality of angles, thereby increasing the path length of light within the solar cell.

Another prior art approach to light trapping comprises the use of conventional photonic crystals in a solar cell. Photonic crystals are composed of regions with a periodic modulation of the refractive index that only allows the propagation of light in certain regions. Photonic crystals are made from layers of dielectric or metallic materials and the modification of light propagation is a result of interference phenomena related to alternating high and low refractive index regions. A related way to control and direct the propagation of light is through diffraction gratings, in which grooves or lines are provided on a planar surface to diffract light to generate unique interference patterns, which then dictate the light propagation direction.

Recent studies have shown that light guiding has also been achieved by applying surface plasmonic polaritons (SPP), which are a transverse magnetic (TM) mode of an electromagnetic wave that propagates at the interface between a metal and a dielectric. Such studies used a prism to induce the coupling between the SPPs to photons, creating propagating modes and bandgaps. In other arrangements, diffraction-grating based surface plasmon resonances have been utilized in medical and biological research where metallic gratings were used to generate resonance between surface plasmons to diffract light at various angles. The change of the angle was used as an indicator to molecular interactions on the grating surface.

Some embodiments of the invention can use metallic 1-dimension (1-D) or 2-dimension (2-D) plasmonic nanostructures to diffract and guide light in solar cells. These plasmonic nanostructures, also called metallic nanostructures, function as a diffraction grating or 2-D photonic crystal but do not necessary have the geometry a traditional diffraction grating has (linear grooves or rulings) or a photonic crystal has (composed of dielectric materials, having repeating alternating regions of high and low dielectric constants). These planar structures can diffract light at directions determined by the surface plasmon waves and the fixed geometry of the nanostructures. Such planar structures can be placed at the bottom or on the top of a solar cell, to redirect light back to the solar cell, or to guide light into the cell, increasing the absorbance of light within the cell. The planar structures can also be placed both on the front and rear surfaces of the absorber to provide the most benefits in guiding light into a solar cell, and maximizing the light trapping effect.

When light is incident on a planar plasmonic device, the scattering of the light waves is affected by three processes. First, the incident light undergoes typical diffraction on the nanostructured planar plasmonic device, similar to light incident on a metallic grating. Second, when a resonant condition as discussed below is met, the incident light excites SPPs. These SPPs propagate along the surface of the nanostructure. Surface features induce changes to the dispersion relations of SPPs owing to the interaction between the SPPs and the surface features. As a result, SPPs scatter into other SPPs propagating in other directions, or the SPPs decay by emitting photons. The SPPs and the resultant light scattering can be controlled by the design of the surface features. Mie plasmons can be excited as well when nanostructures include voids that are inside of the film at some distance from the surface. When Mie plasmons resonate with diffracted beams and SPPs, intensified diffraction is achieved.

The first scattering mechanism involves a plurality of incident wavelengths that can be efficiently diffracted at angles nearly parallel to the interface, generating well-known waveguiding modes. These wavelengths are strongly absorbed in the solar cell. The condition for this mechanism to occur is that the round-trip phase difference between the light waves from the bottom and top of the absorbing layer is an integral multiple of 2π.

The diffractive light-trapping mechanism is modeled by a simple analytical model. With an absorber thickness of d₂, all resonances require a round-trip phase change 2 mπ, so that the perpendicular component of the light wave-vector is k_{⊥}=πm/d₂. The wavelength of diffracted resonant mode is given by:

λ=2πn(λ)/\sqrt{Gₓ²+G_{y}²+(mπ/d₂)²}(1)

where m is an integer, n is the wavelength dependent refractive index of the absorber layer and Gₓ, G_{y} are the components of reciprocal lattice vectors (e.g. Gₓ=i(2π/a); G_{y}=j(2π/a) for a square lattice). The diffraction resonances occur for integer values of i, j and m and exhibit peaks in the absorption for wavelengths near the solar cell band edge. The peaks overlap and form the overall absorption enhancement. It is preferable to have several diffraction resonances within the wavelength window near the solar cell band edge, where the absorption length of photons is longer than the absorber layer thickness.

The second mechanism involves the generation of surface plasmons. To excite SPPs on a surface having periodic structures such as periodic array of holes, the incident light and the geometry of the structures need to satisfy the resonant condition described as:

$$λ = {a}_{0} \sqrt{\frac{{ɛ}_{1} {ɛ}_{2}}{{ɛ}_{1} + {ɛ}_{2}}} \qquad ( 2 )$$

where λ is the wavelength of the incident electromagnetic radiation; a₀ is the lattice constant; ∈₁ and ∈₂ are real portions of the respective dielectric constants for the metallic substrate and the surrounding medium in which the incident radiation passes prior to irradiating the metal film. For a non-periodic structure, the above equation may be modified to describe the resonant condition for a non-periodic structure. For example, where configuration comprises a single hole at the center of a single annular groove, the resonant condition may be described as:

$$λ = ρ \sqrt{\frac{{ɛ}_{1} {ɛ}_{2}}{{ɛ}_{1} + {ɛ}_{2}}} \qquad ( 3 )$$

where ρ denotes the radius of the annular groove from the centrally positioned aperture within the annular groove. Surface plasmons are waves in the periodic array that generate very strong electric fields in the absorber layer of the solar cell. The high electric field and concentration of light at resonant frequencies generates high absorption of incident wavelengths that satisfy this incident condition.

The coupling between SPPs and Mie plasmons can be effectively modified by tuning the geometry of the nanostructures such as the void diameter and/or the period of the void lattice or by the angle of the incident light. By the tuning the geometry of the nanostructures on a planar plasmonic device, one can couple or decouple the resonance between plasmons and incident and/or diffracted light of certain wavelengths, controlling the propagating direction and magnitude of the light.

One or multiple such planar plasmonic devices can be used in conjunction with an absorbing layer to guide the light into the layer, reflect light back to the absorbing layer effectively after they pass through the solar cell without absorption, and to trap light with the absorbing layer.

Although the theoretical description given herein is thought to be correct, the operation of the devices described and claimed herein does not depend upon the accuracy or validity of the theoretical description. That is, later theoretical developments that may explain the observed results on a basis different from the theory presented herein will not detract from the inventions described herein.

While the present invention has been particularly shown and described with reference to the preferred mode as illustrated in the drawing, it will be understood by one skilled in the art that various changes in detail may be affected therein without departing from the spirit and scope of the invention as defined by the claims.

What is claimed is:

1. A planar plasmonic device, comprising:
a first material layer having a surface configured to receive at least one photon of incident light;
a patterned plasmonic nanostructured layer disposed adjacent and optically coupled to said first material layer, said patterned plasmonic nanostructured layer including a selected one of:
a) at least a portion of a surface of said patterned plasmonic nanostructured layer comprises a textured surface, and
b) at least one compound nanofeature comprising a first material disposed adjacent to a second material within said compound nanofeature.

2. The planar plasmonic device of claim 1, wherein said first material layer comprises a silicon wafer.

3. The planar plasmonic device of claim 1, wherein said planar plasmonic device comprises an amorphous silicon layer with a superstrate structure.

4. The planar plasmonic device of claim 1, wherein said patterned plasmonic nanostructured layer comprises a plurality of nanofeatures having a shape selected from the group of shapes consisting of round, triangular, elliptical, cylindrical, square, rectangular, regular polygon, and irregular polygon.

5. The planar plasmonic device of claim 1, wherein said patterned plasmonic nanostructured layer comprises a plurality of nanofeatures having a selected one of physical feature of depression and physical feature of protrusion.

6. The planar plasmonic device of claim 1, wherein said patterned plasmonic nanostructured layer comprises a plurality of nanofeatures comprising patches of a metal.

7. The planar plasmonic device of claim 1, wherein said patterned plasmonic nanostructured layer comprises a patterned metal film.

8. The planar plasmonic device of claim 7, wherein said patterned metal film comprises a textured surface.

9. The planar plasmonic device of claim 7, wherein said patterned metal film is disposed adjacent to a textured surface, said textured surface is provided on a selected one of a surface of said first material and a surface of said second material.

10. The planar plasmonic device of claim 7, wherein said metal film comprises a metal selected from the group consisting of silver, gold, copper, aluminum, nickel, titanium, chromium, silver alloy, gold alloy, copper alloy, aluminum alloy, nickel alloy, titanium alloy, chromium alloy, and a combination thereof.

11. The planar plasmonic device of claim 1, wherein said first material and said second material of said at least one compound nanofeature are a first metal and a second metal, respectively.

12. The planar plasmonic device of claim 1, wherein said patterned plasmonic nanostructured layer comprises a plurality of nanofeatures formed on a surface of said first material layer and at least some of said plurality of nanofeatures are coated with a material that supports plasmon waves.

13. The planar plasmonic device of claim 12, wherein said material that supports plasmon waves comprises a metal selected from the group consisting of silver, gold, copper, aluminum, nickel, titanium, chromium, silver alloy, gold alloy, copper alloy, aluminum alloy, nickel alloy, titanium alloy, chromium alloy, and a combination thereof.

14. The planar plasmonic device of claim 12, wherein said material that supports plasmon waves comprises a transparent conductive oxide material.

15. The planar plasmonic device of claim 14, wherein said transparent conductive oxide material is an oxide selected from the group consisting of indium-tin-oxide (ITO) and zinc oxide (ZnO).

16. The planar plasmonic device of claim 1, wherein said planar plasmonic device further comprises at least one solar cell layer electrically coupled within an integrated solar cell having an integrated solar cell positive terminal and an integrated solar cell negative terminal.

17. The planar plasmonic device of claim 16, wherein said planar plasmonic device further comprises a mirror.

18. The planar plasmonic device of claim 16, wherein said planar plasmonic device further comprises at least one wavelength conversion layer.

19. The planar plasmonic device of claim 16, wherein said planar plasmonic device is configured as a selected one of a front layer of an integrated solar cell and a rear layer of said integrated solar cell.

20. The planar plasmonic device of claim 16, wherein said planar plasmonic device comprises a quarter-wave coating anti-reflective material.
